(19) United States
(12) Patent Application Publication
(10) Pub. No.: US 2013/0193233 A1
(43) Pub. Date: Aug. 1, 2013

(54) FOAMING AEROSOL ACTUATOR AND METHODS OF MAKING THE SAME

(71) Applicant: Steven A. Sell, Belton, MO (US)

(72) Inventor: Steven A. Sell, Belton, MO (US)

(73) Assignee: MEADWESTVACO CALMAR, INC., Richmond, VA (US)

(21) Appl. No.: 13/876,699

(22) PCT Filed: Oct. 4, 2011
(86) PCT No.: PCT/US11/54737

§ 371 Date: Mar. 28, 2013

Related U.S. Application Data
(60) Provisional application No. 61/390,009, filed on Oct. 5, 2010.

(51) Int. Cl. B05B 1/14; B65D 83/00; B05B 7/30

(52) U.S. Cl. CPC B05B 7/30
USPC 239/462; 222/190; 239/343; 222/402.13

(57) ABSTRACT

An aerosol actuator and manifold for dispersing an aerosol product wherein the manifold includes one or more air vents to promote the foaming of an aerosol product dispersed from the aerosol actuator. In some embodiments, the one or more air vents may be positioned downstream of an orifice cup mounted on the orifice of the manifold.

### CROSS-REFERENCE TO RELATED APPLICATIONS

This application claims the benefit of U.S. Provisional Application No. 61/390,009, entitled “FOAMING AEROSOL ACTUATOR AND METHODS OF MAKING THE SAME,” filed 5 Oct. 2010, and incorporates the same herein by reference in its entirety.

### BACKGROUND OF THE INVENTION

1. Field of the Invention

The invention relates to aerosol actuators and manifolds and more particularly to manifold configuration which allow the foaming of an aerosol product in inert gas such as nitrogen.

2. State of the Art

Trigger actuated aerosol dispensers, when dispensing hydrocarbon propelled formulas, have a resultant bearding effect, or build-up of foam, at the outlet or orifice of the dispenser due to continued expansion of the hydrocarbon gas within the manifold of the dispenser. The bearding effect is unwanted and is considered a problem in the industry, however, the hydrocarbon propellant is often needed or desired to foam the products.

There is also a push to move away from hydrocarbon propellants in aerosol delivery systems due to environmental and other considerations. As an alternative, the aerosol industry has begun to move to inert gases, such as nitrogen, as propellants for aerosol products. However, such inert gases are unable to cause the products being dispersed to foam because the inert gas does not continue to expand in the same manner as a hydrocarbon gas may expand.

Thus, a method or device for delivering and foaming an aerosol product using an inert gas, and especially nitrogen, is desired. A delivery system which also prevents the unwanted bearding effect is desirable.

### BRIEF SUMMARY OF THE INVENTION

According to certain embodiments of the invention, a manifold for an aerosol application may include one or more openings or air vents. The one or more openings or air vents may be positioned in an orifice of the manifold. In some embodiments, the one or more openings or air vents may be positioned downstream of an orifice cup mounted in the orifice of the manifold.

According to some embodiments of the invention, one or more screens may be positioned in the fluid flow path of a product flowing through a manifold. In some embodiments, the one or more screens may be placed downstream of the one or more openings or air vents in a manifold. In other embodiments, the one or more screens may be placed upstream of the one or more openings or air vents. In still other embodiments, one or more screens may be placed both upstream and downstream of the one or more openings or air vents in the manifold.

### BRIEF DESCRIPTION OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 illustrates an aerosol actuator and aerosol container according to certain embodiments of the invention;

FIG. 2 illustrates an aerosol actuator and aerosol container according to certain embodiments of the invention;

FIG. 3 illustrates various views of a manifold for an aerosol actuator according to various embodiments of the invention;

FIG. 4 illustrates a cross-sectional view of a manifold for an aerosol actuator according to various embodiments of the invention;

FIG. 5 illustrates a cross-sectional view of a manifold orifice having a screen according to various embodiments of the invention; and

FIG. 6 illustrates a cross-sectional view of a manifold orifice having a screen according to various embodiments of the invention.

### DETAILED DESCRIPTION OF THE INVENTION

According to embodiments of the invention, an aerosol actuator may include a manifold having one or more air vents in the manifold orifice. According to certain embodiments of the invention, the one or more air vents may be positioned downstream of an orifice cup mounted in the manifold orifice. According to some embodiments of the invention, one or more screens may be positioned downstream of the one or more air vents. The one or more screens may facilitate foaming of a product dispersed from the manifold.

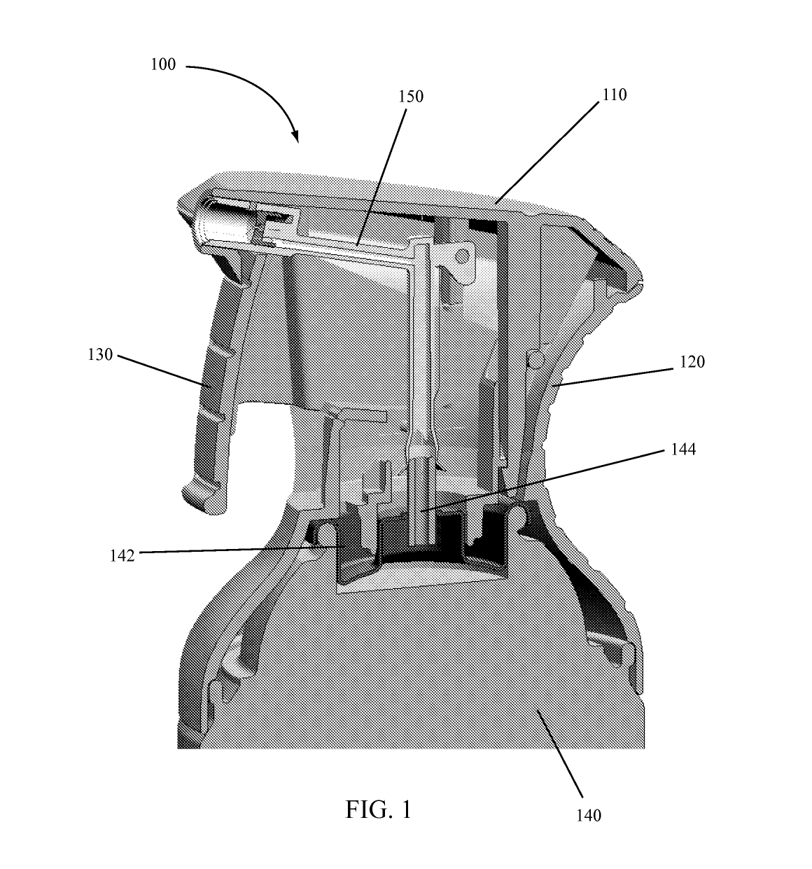

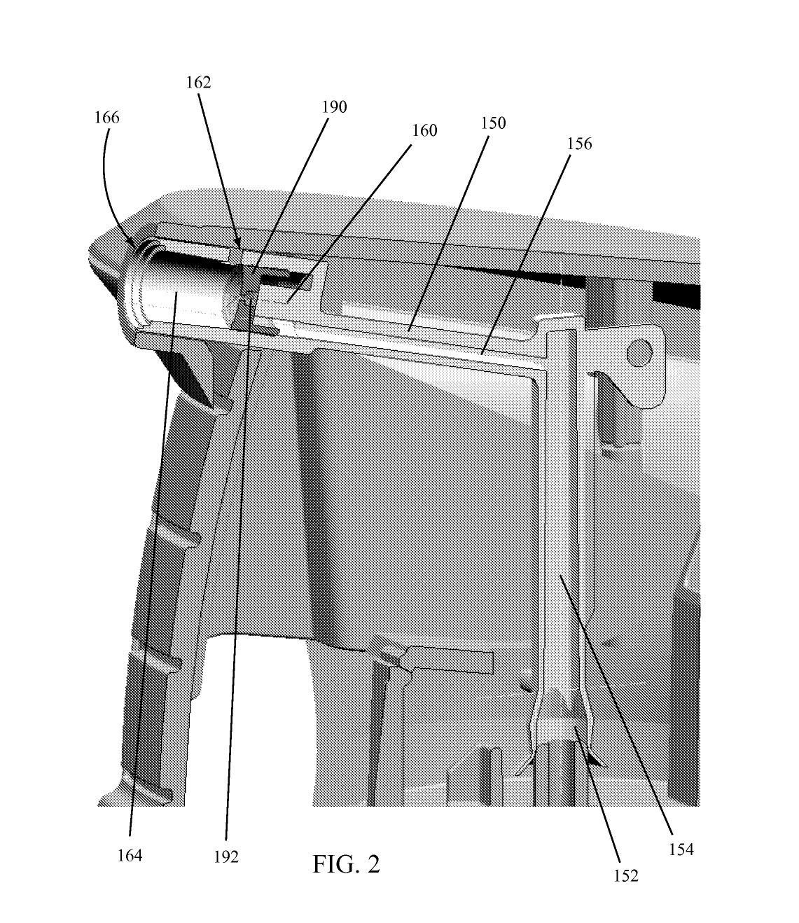

According to embodiments of the invention, an aerosol actuator may be used to foam a product being distributed from an aerosol container. As illustrated in FIGS. 1 and 2, an aerosol actuator 100 according to embodiments of the invention may include a body 120, a cap 110, a trigger 130, and a manifold 150. The body 120 may be attached to an aerosol can 140 or container using conventional connection means. The aerosol can 140 may include a valve cup 142 and a valve stem 144 according to conventional configurations. The manifold 150 may connect to or mate with the valve stem 144 according to conventional means. In some instances, a manifold 150 according to embodiments of the invention may include a valve interface as disclosed in PCT Application Number PCT/US10/050866, which application is incorporated herein by reference in its entirety.

As illustrated in FIG. 2, a manifold 150 may include a valve interface 152 in communication with a first product flow path 154 which is in communication with a second product flow path 156 having a different angle. A manifold orifice 164 may be in communication with the second product flow path 154. The manifold 150 may include an orifice stem 160 extending into a portion of the manifold orifice 164. An orifice cup 190 may be positioned in the manifold orifice 164 about an orifice stem 160 such that the interaction between the orifice cup 190 and the orifice stem 160 forms spin mechanics 192 for a product being dispersed through the manifold 150. The manifold 150 may also include one or more air vents 162. One or more screen ledges 166 may be positioned in the manifold orifice 164 or on an outer perimeter thereof. A screen 180 may be staked to, or attached to, the one of more screen ledges 166.

According to embodiments of the invention, the one or more air vents 162 may be positioned upstream of an orifice cup 190. In addition, the manifold 150 may be fitted into the body 120 and cap 110 of the aerosol actuator 100 such that the one or more air vents 162 may draw air into the manifold orifice 164 as product is dispersed from the manifold 150. For example, as a product is dispersed from the spin mechanics of an orifice cup 190, the dispersing product may draw air through one or more air vents 162 through a venturi effect. Spacing between the placement of the manifold 150 and the cap 110 or body 120 of the aerosol actuator 100 may allow air to flow in such a manner. In some embodiments, projections on the cap 110 or body 120 may disturb the air flow into the one or more air vents 162, causing a turbulent flow.

While a first product flow path 154 and a second product flow path 156 are illustrated, a manifold 150 according to embodiments of the invention may include only a single product flow path as desired.

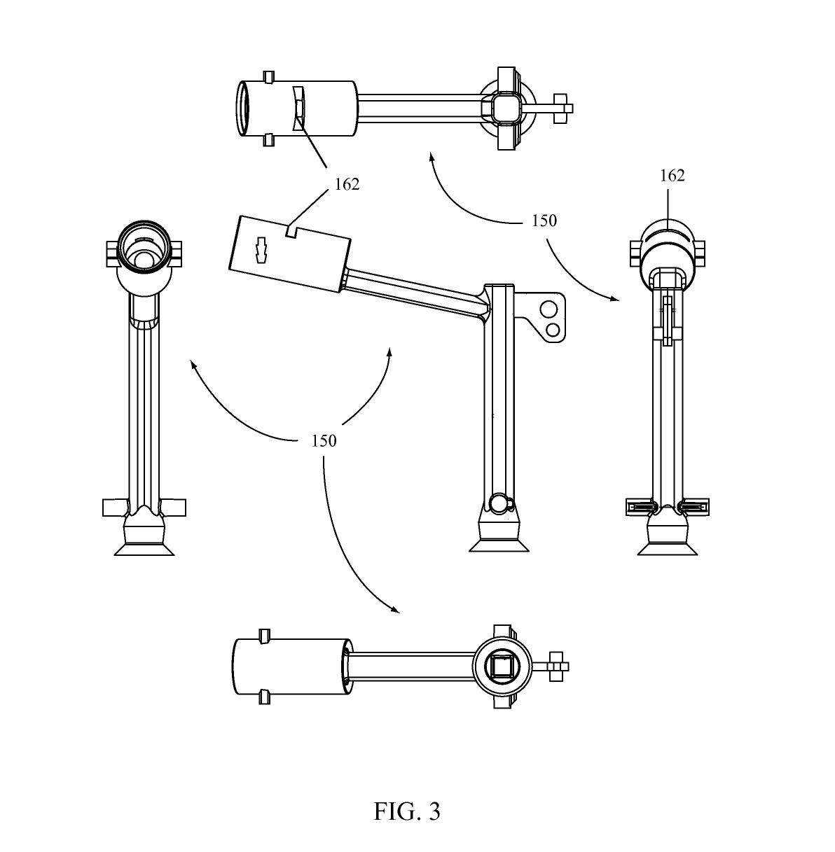

Various views of an exterior of a manifold 150 according to embodiments of the invention are illustrated in FIG. 3. As illustrated, the manifold 150 may include an air vent 162 in a portion of the manifold orifice 164 such that air may enter from an exterior of the manifold 150 into an interior of the manifold orifice 164 where it may interact with a product being dispersed.

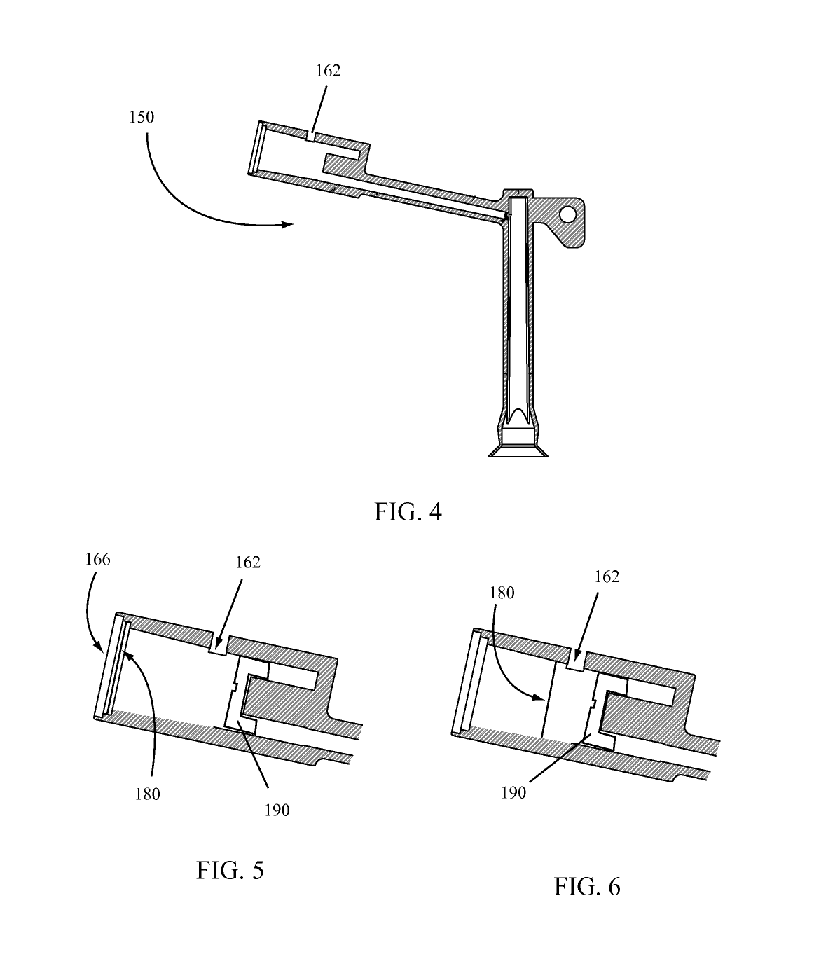

A cross-sectional view of a manifold according to various embodiments of the invention is illustrated in FIG. 4. As illustrated, the manifold 150 may include one or more air vents 162.

According to embodiments of the invention, a screen 180 may be placed within or on an outer portion of the manifold orifice 164 as desired. As illustrated in FIG. 5, a screen 180 may be placed in one or more screen ledges 166. As illustrated in FIG. 6, a screen 180 may be fitted or fixed inside the manifold orifice 164 in any desired location. In some embodiments of the invention, a screen 180 is placed upstream of both the orifice cup 190 and an air vent 162. Depending on the formulation of a product being delivered through the manifold 150, the propellant gas, and other variables, the positioning of one or more screens 180 within the manifold orifice 164 relative to an air vent 162 may alter the consistency of a foam being created.

According to various embodiments of the invention, a screen 180 may be made of any desirable material. In some instances, a screen 180 may be made of a cloth material. In other instances, a screen 180 may be made of stainless steel. In still other instances, a screen 180 may be made of plastic or molded from resin. For example, in some embodiments of the invention, a screen 180 may be molded into a manifold orifice 164 during a bi-injection molding process. In other embodiments, a screen 180 may be staked to, or otherwise attached to, a manifold orifice 164 following the molding of the manifold 150.

According to various embodiments of the invention, a manifold 150 according to embodiments of the invention may be used with an aerosol actuator 100 to deliver or foam a product from an aerosol can. A manifold 150 having one or more air vents 162 downstream of an orifice cup 190 and positioned in a manifold orifice 164 may foam a product being dispersed through the manifold 150. It has been found that a manifold 150 having air vents 1621 configured according to embodiments of the invention provides a foamed product from an aerosol product comprising a product and an inert gas. In addition, the configuration of the manifold 150 according to embodiments of the invention, prevents or helps to prevent the presence of bearding following actuation of the manifold 150 when using an aerosol product comprising an inert gas, such as nitrogen.

While various embodiments of the invention have been described with respect to the aerosol actuator 100 illustrated in the Figures, it is understood that other embodiments of the invention may incorporate a manifold 150 having one or more air vents 162 therein with different aerosol actuator configurations.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

What is claimed is:

1. An aerosol actuator, comprising:
a body;
a cap;
a manifold fitted within the body and cap;
a manifold orifice in the manifold; and
at least one air vent in the manifold orifice.

2. The aerosol actuator of claim 1, further comprising at least one screen positioned downstream of the at least one air vent.

3. The aerosol actuator of claim 1, further comprising an orifice cup positioned in the manifold orifice upstream of the at least one air vent.

4. The aerosol actuator of claim 1, further comprising an orifice cup positioned in the manifold orifice downstream of the at least one air vent.

5. An aerosol delivery system, comprising:
an aerosol container;
a product in the aerosol container;
an inert dispersant in the aerosol container;
a valve cup attached to the aerosol container;
a valve positioned in the valve cup;
a manifold in communication with the valve;
an orifice cup positioned in the manifold; and
at least one air vent in the manifold downstream of the orifice cup.

6. The aerosol delivery system of claim 5, further comprising at least one screen positioned downstream of the at least one air vent.

7. The aerosol delivery system of claim 6, wherein the at least one screen comprises a material selected from the group consisting of cloth, stainless steel, resin and plastic.

8. The aerosol delivery system of claim 5, further comprising:
at least one screen ledge; and
at least one screen mounted in the at least one screen ledge.

9. An aerosol actuator (100) having a body (120) mounted to an aerosol can (140), a manifold (150) contained within a portion of the body (120) and connected to a valve stem (144), and a trigger (130) for actuating the manifold (150), characterized in that the manifold (150) comprises a manifold orifice (164) and at least one air vent (162) in the manifold.

10. The aerosol actuator (100) of claim 9, further comprising an orifice cup (192) mounted in the manifold orifice (164) downstream of the at least one air vent (164).

11. The aerosol actuator (100) of claim 9, further comprising at least one screen (180) mounted in the manifold orifice (164).
